(19) United States
(12) Patent Application Publication
(10) Pub. No.: US 2015/0285942 A1
(43) Pub. Date: Oct. 8, 2015

(54) SOLID STATE PHOTO MULTIPLIER DEVICE

(71) Applicant: General Electric Company, Schenectady, NY (US)

(72) Inventors: Stanislav Ivanovich Soloviev, Ballston Lake, NY (US); Peter Micah Sandvik, Niskayuna, NY (US); Sergei Ivanovich Dolinsky, Clifton Park, NY (US); Cheng-Po Chen, Niskayuna, NY (US); Helene Claire Climent, Sugar Land, TX (US); Sabarni Palit, Guilderland, NY (US)

(73) Assignee: General Electric Company, Schenectady, NY (US)

(21) Appl. No.: 14/244,979

(22) Filed: Apr. 4, 2014

(51) Int. Cl. G01V 5/08; E21B 47/00

(52) U.S. Cl. CPC G01V 5/08; E21B 47/00

(57) ABSTRACT

A method and an apparatus for detecting photons are disclosed. The apparatus includes a solid state photo multiplier device having a plurality of microcells that have a band gap greater than about 1.7 eV at 25° C. The solid state photo multiplier device further includes an integrated quenching device and a thin film coating associated with each of the microcells. The solid state photo multiplier device disclosed herein operates in a temperature range of about −40° C. to about 275° C.

### BACKGROUND

This invention relates generally to solid state photo multiplier (SSPM) devices and, more particularly, to a wide band gap SSPM that operates over a wide temperature range.

There is currently a need for gamma ray detection in the oil well drilling industry. High energy gamma rays reflected from hydrogen (H) bearing compounds underground may indicate specific locations which may have oil. A small, robust sensor capable of detecting such rays is highly desirable and necessary for harsh, down-hole environments where shock levels are near 250 gravitational acceleration (G) and temperatures may vary widely from below room temperature to exceeding 175° Celsius (C).

Several current technologies utilize gamma sensors that include photomultiplier tubes (PMTs) spectrally matched to scintillators. The scintillators emit UV or blue light when excited by a high energy radiation such as gamma radiation, and the PMTs are used to transform UV or blue light signals to readable level electronic signals. However, PMTs have a negative temperature coefficient. Thus, PMTs become less sensitive as temperature increases. PMTs often require high operating voltages and are also fragile and prone to failure when vibration levels are high. For certain applications (e.g., at temperatures exceeding 175° C., where PMTs have less than 50% signal), the lifetimes of PMTs may become prohibitively short, thereby driving up the cost of their use sharply.

In solid state avalanche photodiode (APD)s, a charge carrier created by detected photons is accelerated by an applied high electric field to sufficiently high kinetic energy. It creates secondary charge pairs through impact ionization, resulting in high gain. APDs working in linear mode may be used for some oil well drilling applications. However, APDs working in linear mode are very temperature sensitive, thereby reducing sensitivity and energy resolution of the detector. In a Geiger mode, the APD is operated beyond its break down voltage, resulting in further impact ionization and high gain. A single APD may be limited in detection area, light collection and detection of radiation events. In the oil well drilling application, distinguishing between low and high photon fluxes is desired. An array of APDs is capable of detecting multiple photons and scales to larger detection area, but available APD arrays are made with silicon semiconductor, which have good performance at room temperature but may lose its sensitivity rapidly with increasing temperatures.

Therefore, there is an existing need to have a device that can operate at a wide variety of temperature levels including at temperatures as high as or higher than 175° C., without much deterioration of the detected signals.

### BRIEF DESCRIPTION

Embodiments of the invention are directed towards a solid state photo multiplier device and its method of working.

In one embodiment, a method of detecting high energy radiation in a down-hole drilling application is disclosed. A scintillator produces photons by exposure to the high energy radiation. These photons are detected by a solid state photo multiplier device at a temperature greater than about 175° C. and processed by associated electronics at a temperature greater than about 175° C. to produce signals corresponding to the detected photons. The solid state photo multiplier device includes a plurality of microcells having a band gap greater than about 1.7 eV at 25° C., an integrated quenching device associated with each of the individual microcells, and a thin film coating on a semiconductor surface of each microcell.

In one embodiment, a method is disclosed. The method includes detecting photons by a solid state photo multiplier device at a temperature ranging from about −40° C. to about 275° C. The solid state photo multiplier device includes a plurality of microcells having a band gap greater than about 1.7 eV at 25° C., an integrated quenching device associated with each of the individual microcells, and a thin film coating on a semiconductor surface of each microcell.

In one embodiment, a method is disclosed. The method includes detecting photons by a solid state photo multiplier device over a temperature variation of 200° C. or more. The solid state photo multiplier device includes a plurality of microcells having a bandgap greater than about 1.7 eV at 25° C., an integrated quenching device associated with each of the individual microcells, and a thin film coating on a semiconductor surface of each microcell.

In one embodiment, an apparatus for detecting photons is disclosed. The apparatus includes a solid state photo multiplier device having a plurality of microcells that have a bandgap greater than about 1.7 eV at 25° C. The solid state photo multiplier device further includes an integrated quenching device associated with each of the microcells and a thin film coating on a semiconductor surface of each microcell. The solid state photo multiplier device disclosed herein operates at a temperature ranging from about −40° C. to about 275° C.

### DRAWINGS

These and other advantages and features will be more readily understood from the following detailed description of preferred embodiments of the invention that is provided in connection with the accompanying drawings.

FIG. 1 is perspective view of an apparatus including the solid state photo multiplier device, according to an embodiment of the present invention;

FIG. 2 is a schematic view of the solid state photo multiplier device, according to an embodiment of the present invention;

FIG. 3 is a schematic view of a discriminator, according to an embodiment of the present invention;

FIG. 4 is a schematic view of an individual microcell of the SSPM with integrated polysilicon quenching resistor, according to an embodiment of the present invention; and

FIG. 5 is a schematic view of an individual microcell of the SSPM with an integrated quenching device including a p-n junction diode, according to an embodiment of the present invention.

### DETAILED DESCRIPTION

Aspects of the present invention will now be described in more detail with reference to exemplary embodiments thereof as shown in the appended drawings. While the present invention is described below with reference to preferred embodiments, it should be understood that the present invention is not limited thereto. Those of ordinary skill in the art having access to the teachings herein will recognize additional implementations, modifications, and embodiments, as well as other fields of use, which are within the scope of the present invention as disclosed and claimed herein, and with respect to which the present invention could be of significant utility.

In the following description, whenever a particular aspect or feature of an embodiment of the invention is said to comprise or consist of at least one element of a group and combinations thereof, it is understood that the aspect or feature may comprise or consist of any of the elements of the group, either individually or in combination with any of the other elements of that group.

In the following specification and the claims that follow, the singular forms “a,” “an,” and “the” include plural referents unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “about” or “substantially,” may not be limited to the precise value specified, and may include values that differ from the specified value. In at least some instances, the approximating language may correspond to the precision of an instrument for measuring the value.

An aspect of the present invention is directed to a solid state photo multiplier (SSPM) device for use in oil well drilling applications in harsh, down-hole environments where shock levels are near 250 gravitational acceleration (G). Further, the SSPM device described herein operates at lower voltages, and is operable at a wide temperature range, is less sensitive to temperature variation, and is more reliable than the conventionally used PMTs.

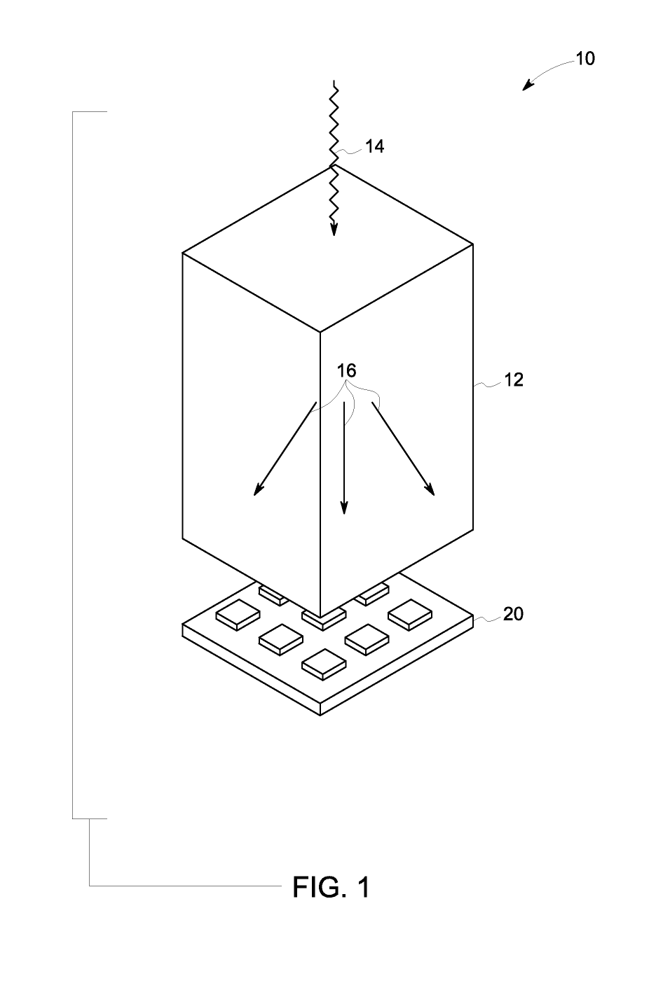

In an exemplary embodiment disclosed in FIG. 1, a system 10 may include a photon generator 12 that is capable of converting high energy radiation 14 into photons 16. The photon generator 12 may include any device such as a scintillator, or a phosphor. The SSPM device 20 may be exposed to the generated photons 16 to detect the photons 16 and convert them to electrical or electronic signals (not shown) that can be detected by an associated electronics to determine time, energy, and position of the impinged high energy radiation.

The disclosed SSPM device is configured to detect impinging photons while operating at a wide temperature window, without substantial loss of photon detection capability. The SSPM device disclosed herein is capable of operating at a temperature range of sub-room temperatures to elevated temperature, such as, for example, −50° C. to 275° C. In one embodiment, the SSPM device is configured to operate at a temperature range of −40° C. to 250° C.

In one embodiment, the SSPM device 20 is configured to operate at elevated temperatures such as, for example, greater than 175° C. As used herein, the SSPM device is “configured to operate at a temperature greater than 175° C.” means that the device is capable of operating at temperature greater than 175° C., without losing its capability of operating at temperatures less than 175° C. In a further embodiment, the SSPM device is configured to operate at temperatures even greater than 200° C. In another embodiment, the SSPM device may be operated at temperatures below room temperature. In one embodiment, the SSPM may be configured to operate at a temperature less than about −40° C.

In one embodiment, the disclosed SSPM device is configured to detect impinging photons while operating at a wide temperature range of over 200° C., without substantial loss of photon detection capability. As used herein “detecting photons while operating at a wide temperature range of over 200° C.” means that a single arrangement of device is capable of operating in this temperature window without any substantial change in the composition or arrangement of the device for the operation of any sub-window of this temperature range. For example, the device in its one configuration may be able to operate from −25° C. to up to 175° C., without the need to replace any of its parts or without the need of extra protection to any part of the device. In another exemplary embodiment, the device in its one configuration may be able to operate from 0° C. to up to 200° C., without the need to replace any of its parts or without the need of extra protection to any part of the device.

As used herein, the SSPM device 20 is “capable of operating” or “configured to operate” at a temperature range means that there is no substantial variation in the peak quantum efficiency of an active area of the SSPM device at any temperature window of the disclosed temperature range. An active area of the SSPM device is herein defined as the photosensitive area of the device. As used herein in this application, the SSPM device is said to have substantial variation in the quantum efficiency, if the variation in the peak quantum efficiency of the active area in a 10° C. temperature window in the operating temperature range is more than about 5% of the peak quantum efficiency of an adjacent 10° C. temperature window. The value and the wavelength corresponding to the peak quantum efficiency are designed by tuning the thickness and doping concentration of the semiconductor layers 62, 64, 66, and the composition and thickness of the antireflective coating 72.

The SSPM device 20 disclosed herein may be configured to operate with a high quantum efficiency. In one embodiment, the active area of the solid state photo multiplier device has a peak quantum efficiency of greater than 40%. In another embodiment, the peak quantum efficiency of the active area of the solid state photo multiplier device is greater than 50%.

In one aspect, the SSPM device 20 is constructed using a wide band gap semiconductor material, having a band gap greater than about 1.7 eV at 25° C., and capable of detecting wide range of photons including visible light, and UV photons. The disclosed SSPM device 20 also provides excellent photon resolving power for weak photon pulses as compared to other candidate solid state devices such as avalanche photodiodes operating in a linear regime, or single photon avalanche diodes that work in the Geiger mode.

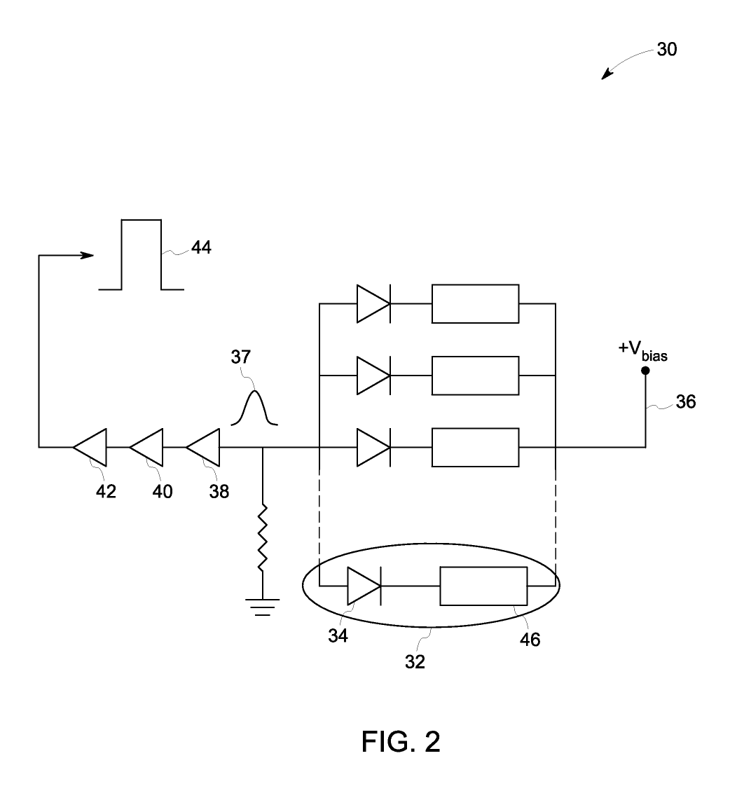

In one embodiment, the SSPM device 20 includes an array 30 of single pixel (microcell) 32 of avalanche photodiode (APD) 34 operating in Geiger mode, as shown in FIG. 2. Herein the array 30 is biased above the breakdown voltage, and a single absorbed and captured photon can trigger avalanche. Avalanche causes the charge stored in each APD 34 to discharge in a fast current pulse. The quenching device 46 limits the recharging current. In one embodiment, the SSPM device 20 is the array 30 described in FIG. 2 having the microcell 32 of avalanche photodiodes having a band gap greater than about 1.7 eV at 25° C.

The system 10 may include a large number of solid state photo multiplier devices 20 tiled adjacent to one another covering a comparatively large area. In one embodiment, the array of solid state photo multiplier devices are tiled adjacent to one another in the system 10 to cover an area of 5 mm² or greater.

The circuit for processing the current pulse signal may include a high voltage power supply 36, one or more pre-amplifiers 38, shaping amplifier 40 or integrator, and a comparator or discriminator 42. The output of the discriminator 42 may be in the form of a logic pulse 44 every time a photon 16 is detected. The amplifiers 38 may be used to amplify the small amplitude and short duration pulses 37, and the shaping amplifiers 40 may be used to amplify and filter the signal to be further processed. The shaping amplifiers 40 may collect or integrate the signal from the SSPM device 20 over a set period of time, as the impingement of photons from a single high energy radiation event may be spread out over a longer time constant than the response time of the SSPM device 20. This spreading of photon emission from a high energy radiation event may be dependent on the material of the photon generator 12 used along with the SSPM device 20, and with the operating temperature. By collecting the photon signals over a range of time periods, the overall signal to noise ratio gets improved and the circuit becomes efficient in distinguishing the energy level of the incoming high energy radiation, as the number of photons generated in the photon generator 12 is proportional to the energy of incoming radiation. In one embodiment, the photon signals are collected in a time period spanning from about 1 nanosecond to 10 microseconds. In one embodiment, this time ranges from about 10 nano seconds to about 1 microsecond.

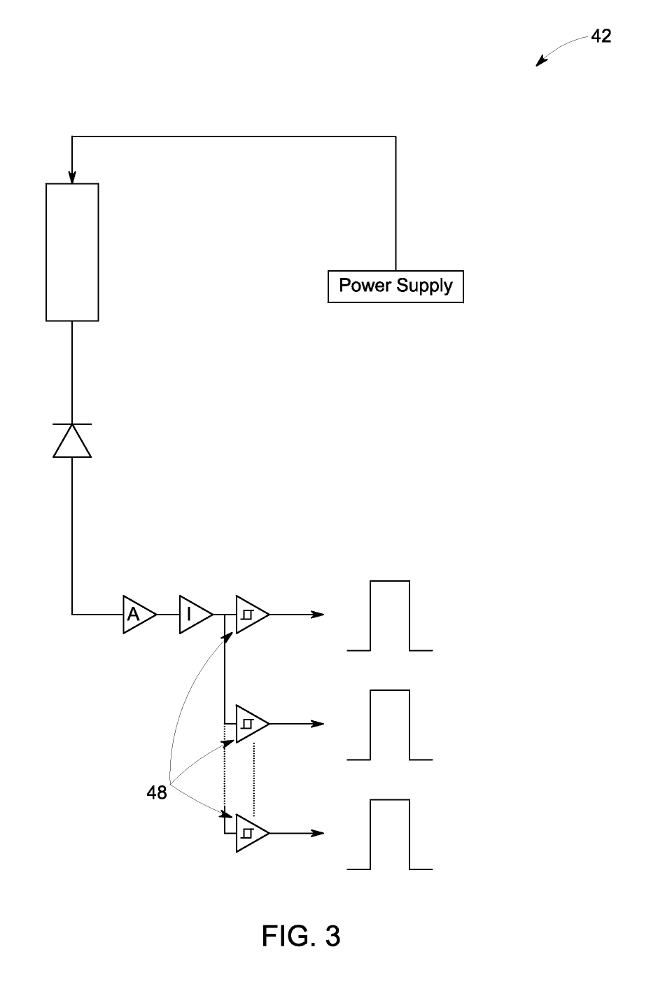

Once the photon signal is collected and pulse shape is sharpened by the shaping amplifier 40, the discriminator 42 converts the signal into a binary logic signal. If the signal is below a set threshold, there may not be any output from the discriminator, however, if the signal is above the set threshold, then the discriminator 42 may generate the logic pulse 44 of a certain pulse period for subsequent circuitry to count the pulse 44 and thus represent the count of high energy radiation events. The discriminator 42 circuit may further have an array of or range of different threshold voltages 48, where the incoming high energy radiation energies can be identified and sorted into more than 2 energy levels, as shown in FIG. 3.

For applications such as in oil and gas exploration, and in particular in measurement while drilling (MWD), the sensor and electronics are generally battery operated, hence it is desirable that the SSPM signal processing circuit be made operational in as low power as possible. Further, since these applications expose the sensor and associated electronics to harsh and high temperature environments, and be made operational across a wide range of temperatures, the electronic circuitry needs to address the change in output characteristics of the SSPM device 20 across the operational temperature range. In one embodiment, the amplifier 38 is a variable gain amplifier, used for temperature compensation. The variable gain amplifier may adjust its gain in response to the signal level of the SSPM device. Further, a time constant of the shaper 40 may be variable with temperature, as the response time of the SSPM device may change with temperature. In one embodiment, the discriminator 42 has a variable threshold setting matched to the variation in SSPM device 20 dark count and output levels across the temperature range of operation.

The SSPM device 20 may be made of different high temperature withstanding materials, depending on the temperature of operation of the device. Typically, the high temperature operation of the SSPM device may be aided by using silicon carbide (SiC), gallium phosphide (GaP), or gallium nitride (GaN) based materials. In one embodiment, SiC, or GaN material is used for the SSPM device. In one embodiment, alloys of indium gallium nitride (InₓGa₁₋ₓN), alloys of aluminum indium gallium nitride (AlₓIn_{y}Ga_{1-x-y}N), alloys of aluminum gallium arsenide (AlₓGa₁₋ₓAs), 0≦x, y≦1 may be used. In one embodiment, the SSPM device is constructed using SiC, GaP, GaN, alloys of InₓGa₁₋ₓN, alloys of AlₓIn_{y}Ga_{1-x-y}N, alloys of AlₓGa₁₋ₓAs, or combinations thereof.

Once current starts flowing in the circuitry, it should then be stopped or ‘quenched’ before the next high energy radiation pulse. The Geiger mode operation may be achieved by passive quenching of the microcell 32 photodiodes 34 in reverse bias. In one embodiment, the passive quenching is achieved by integrating an on-chip quenching device 46 with each of the photodiode 34. The integrated quenching device 46 may be a resistor, a diode, a transistor, a capacitor, or a combination thereof. Further, the integrated quenching device 46 may include a semiconductor, poly wide band gap semiconductor, a polysilicon, metal, ceramic, or a combination thereof. The output of the photo-detector 30 is the sum of individual pixels 32. Depending on the number of activated individual pixels 32, the height of the pulse of the array 30 changes.

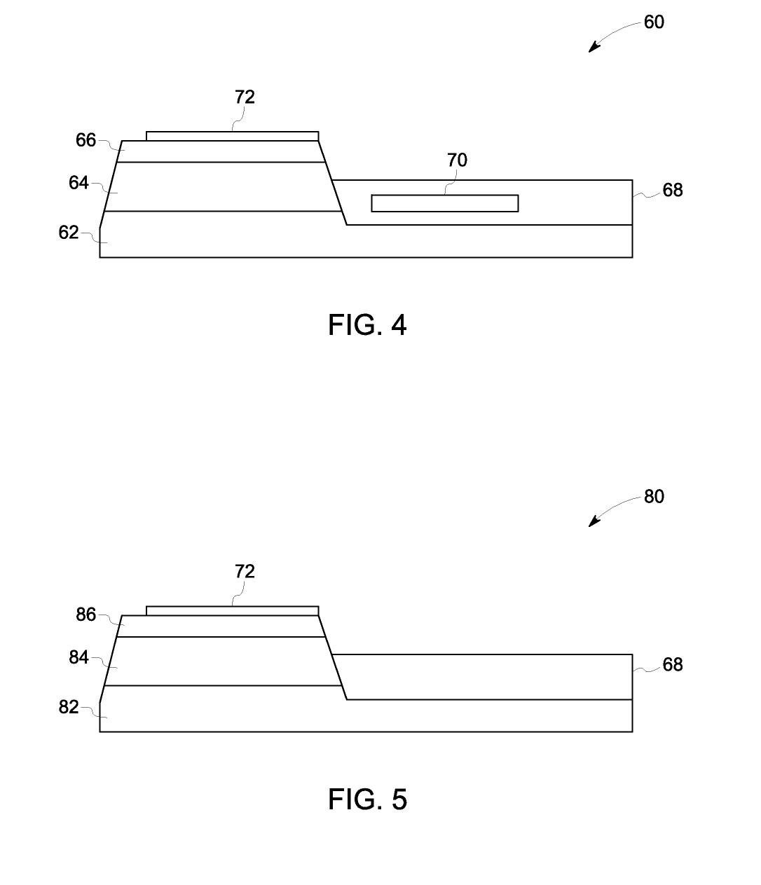

In one embodiment, the integrated quenching device 46 is a quenching resistor. The quenching resistor may be composed of a high resistivity material with a sheet resistance in a range from about 10¹ to 10⁹ Ohm/square. In an exemplary embodiment, the quenching resistor is composed of a polysilicon material having a sheet resistance in a range from about 10⁶ to 10⁹ Ohm/square. FIG. 4 shows an individual microcell of the SSPM with integrated polysilicon quenching resistor 70. The exemplary microcell 60 includes a PN junction diode composed of multiple epitaxial layers, where layer 62 is of the first doping type, and layers 64 and 66 are of the second doping type. Each of the layers 62, 64, and 66 may be composed of additional epitaxial layers for the purpose of achieving light absorption and APD operation. The epitaxial layers are grown on a substrate (not shown). The Geiger mode operation is achieved through a quenching layer 68, embedded in a dielectric, but connected as appropriate through contacts (not shown) and other layers of material (not shown) to the APD and to the rest of the circuit.

In one embodiment 80, as shown in FIG. 5, the integrated quenching device 46 (FIG. 2) involves use of P-N junction diode. In this case layer 82 and 86 are of the first doping type and layer 84 is of the second doping type, such that a second PN junction formed between layers 84 and 86 that is in series with the PN junction of the APD and that gets forward biased and quenches the device.

According to an embodiment of the present invention, the SSPM device 20 (FIG. 1) may include a thin film coating 72 on a semiconductor surface of each of the microcells as shown in FIG. 4. In one embodiment, the thin film coating 72 serves as a passivation layer for providing surface passivation to the device. In another embodiment, it may be used as an anti-reflective layer to increase light collection efficiency and overall detection efficiency of the SSPM device in the wavelength range of interest. The thin film coating may also be used as optical filters to selectively pass through a pre-determined range of wavelengths of light. Further, this thin film coating may be in the thickness range of 10 nm to 10 microns.

In one embodiment, a silicon dioxide (SiO₂) layer may be used as the thin film coating. In a further embodiment, the SiO₂ layer is used as an anti-reflecting layer. In other embodiments SiO₂ Hf0₂, Al₂O₃, CaF₂, MgF₂ or a combination of these may be used as the thin film coating, which may function as anti-reflective coating. In another embodiment, the anti-reflective layer may be a nanostructured or textured surface. In addition, a phosphorous silicate glass (PSG) layer (not shown) may be deposited on the device to control electrical properties otherwise affected by mobile ions. In one embodiment, the active area of the microcell is typically covered by the thin film layer. As used herein, “an active area of the microcell” is defined as the photosensitive area, independent of the geometry of the microcell.

Further, the individual microcell diodes 60 may have sloped mesa sidewalls, minimizing an amount of electrical charge present near the edges of the mesa, thereby lowering the electrical field in that immediate area. The mesa may be of a one-step etch or a two-step etch sidewall. In an embodiment of the one step mesa, the entire mesa has a sloping sidewall, which may vary in slope from 5 degrees to 80 degrees. In the two step mesa, the sidewall may have a vertical section, and a sloping section. A photoresist, ion-etch process, or a fluorine-based chemistry may be used to form sloped sidewall mesas of the SSPM device.

The SSPM device structure may be built with a specific crystal orientation during fabrication, such as 4 degrees off-axis. For example, when specific crystalline phase of 4H of a SiC material is used, the SSPM device is noted to have a positive temperature coefficient, which is particularly attractive for a SiC photodiode due to the requirement of ionization in an avalanche process. 4H SiC is a material with a wide band gap (^{˜}3.2 eV) and a robust chemical nature. This material can absorb UV light rays. Due at least in part to the wide band gap, the device of an embodiment of the present invention may operate at high temperatures. The device further uses a p-n junction, via the epitaxial layers of a first type dopant with a contact layer of a second type dopant. This may be a location for avalanche once a high reverse bias is applied to the device.

Further, defects in the material of the SSPM device may cause some pixels to have higher dark currents, leading to greater dark counts. Eliminating these bad pixels would enhance the functional efficiency of the SSPM device. In one embodiment, the bad pixels of SSPM device of the present invention are eliminated using an integrated microfuse element to each of the pixel output (not shown). Wafer level screening may be carried out to identify the bad pixels and the micro-fuse connecting that pixel output to the array may be blown by heat, excess current across the fuse, or by laser pulses, thus disconnecting that pixel from the array. In another embodiment, the bad pixels are completely cut-off the circuit by processing them using a high-intensity laser.

In large SSPM arrays, it may be necessary to divide the array into numerous sub-arrays and the signal from each sub-array is processed with separate amplifier, shaper, and discriminators. The purpose here is to avoid combining the dark counts or noise signal from the collection of SSPM devices into one single channel. By separately processing the SSPM sub-array signal, the threshold can be set lower in the separate discriminators and a smaller photon flux can be detected. Accordingly, in one embodiment, the array 30 (FIG. 2) of the SSPM is constructed using multiple sub arrays (not shown). Instead of connecting all pixels of the SSPM together, sub arrays are connected and configured to be eliminated from the rest of the array 30, if the dark count from one sub array is found to be high during wafer screening. A summing circuit (not shown) may be added to interpret the numerous signal pulses from the numerous discriminators and combining them in a way to generate only one pulse as final output.

In one embodiment, a plurality of scintillators is coupled to SSPM sub-arrays. The sub-arrays may independently process the photons detected from the associated scintillators and process to be combined as an output of the SSPM device.

In one embodiment, the SSPM device is strategically designed to be adjacent to an optical coupler (not shown) for improved light collection from the associated scintillator.

In one embodiment, the SSPM device may be used as a densitometer. In one embodiment, the densitometer may be used in a gamma-ray density logging tool. The densitometer may be comprised of a wide band gap SSPM device 20 that detects light of wavelengths less than about 500 nm, in conjunction with a high energy radiation source to interrogate samples or the formation and borehole surrounding the logging tool.

In one aspect of the invention, a method for detecting photons in a wide temperature range by using a SSPM device is disclosed. The temperature range in which the SSPM device operates may be 200° C. or more. The SSPM device includes a plurality of microcells having a bandgap greater than about 1.7 eV at 25° C., an integrated quenching device associated with each of the individual microcells and an anti-reflective coating on a semi-conductor surface of each of the microcells.

The SSPM device may be operated at harsh environments of high temperature and high vibration, and may further include an associated electronics processing the detected photons over a temperature variation of 200° C. or more. In one embodiment, the method of detecting the photons using this SSPM device may further include associated variable gain amplifier and noise reduction electronics. The noise reduction electronics may further include a multiplexing and summing circuit. The gain of the associated variable gain amplifier may be configured to set dynamically according to signal levels of the SSPM device.

Operating the SSPM in this method may further allow differentiation of a detected high energy radiation of at least two different energy levels. The different energy levels may further be assigned with different counts for each energy levels. In one embodiment, the detected high energy radiation may be differentiated by an energy resolution less than about 50% for a radiation in a range from about 50 keV to about 10 MeV. In a further embodiment, the energy resolution is less than 20% for radiation in a range from about 50 keV to about 10 MeV.

A goal of an SSPM device of an embodiment of the present invention involves detecting low levels of ultraviolet (UV) photons from scintillators (or other devices) excited by gamma rays, neutrons or X-rays and transforming a signal to an electrical signal. The SSPM device of an embodiment of the present invention may be used specifically in harsh (e.g., high vibration, high temperature, etc.) environments, requiring robust materials. An aspect of the present invention is directed to an n-p type avalanche photo diode array rather than a p-n type device, which is more difficult to realize given its high sensitivity to material defects. The SSPM device of the present invention may operate within a breakdown region of the SiC semiconductor material (e.g., electric field of 1-3 MV/cm).

Accordingly, a method for detecting a high energy radiation in a harsh environment down-hole drilling or wire line application includes exposing a scintillator to the high energy radiation and producing photons, and detecting the photons by the solid state photo multiplier device at a temperature greater than about 175° C. The detected photons are further processed to be converted into electrical signals using an associated electronics operating at temperature greater than about 175° C.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A method of detecting a high energy radiation in a down-hole drilling application, the method comprising:
detecting the high energy radiation by producing photons in a scintillator exposed to the high energy radiation;
detecting the photons by a solid state photo multiplier device at a temperature greater than about 175° C.; and
processing the detected photons at a temperature greater than 175° C. using an associated electronics producing signals corresponding to the detected photons, wherein the solid state photo multiplier device comprises:
a plurality of microcells having a bandgap greater than about 1.7 eV at 25° C.;
an integrated quenching device associated with each of the individual microcells; and
a thin film coating on a semiconductor surface of each microcell.

2. The method of claim 1, further comprising increasing signal to noise ratio of the produced signals at a temperature greater than about 175° C., using a noise reduction electronics.

3. The method of claim 1, wherein an active area of the solid state photo multiplier has a peak quantum efficiency greater than about 40%.

4. The method of claim 1, wherein a thickness of the thin film coating is in a range from about 10 nm to about 10 microns.

5. A method, comprising: detecting photons by a solid state photo multiplier device at a temperature ranging from about −40° C. to about 275° C., wherein the solid state photo multiplier device comprises:
a plurality of microcells having a bandgap greater than about 1.7 eV at 25° C.;
an integrated quenching device associated with each of the individual microcells; and
a thin film coating on a semiconductor surface of each microcell.

6. The method of claim 5, further comprising processing the detected photons at a temperature ranging from about −40° C. to about 275° C. using an associated electronics producing signals corresponding to the detected photons.

7. The method of claim 6, further comprising increasing signal to noise ratio of the produced signals at a temperature ranging from about −40° C. to about 275° C., using a noise reduction electronics.

8. The method of claim 7, further comprising dynamically setting gain of an associated variable gain amplifier according to signal levels of the solid state photo multiplier device.

9. The method of claim 5, further comprising detecting a high energy radiation by producing the photons in a scintillator exposed to the high energy radiation.

10. The method of claim 9, further comprising differentiating high energy radiation of at least two different energy levels and assigning counts for each energy level.

11. The method of claim 5, wherein a thickness of the thin film coating is in a range from about 10 nm to about 10 microns.

12. A method, comprising:
detecting photons by a solid state photo multiplier device over a temperature variation of 200° C. or more, wherein the solid state photo multiplier device comprises:
a plurality of microcells having a bandgap greater than about 1.7 eV at 25° C.;
an integrated quenching device associated with each of the individual microcells; and a thin film coating on a semiconductor surface of each microcell.

13. The method of claim 12, further comprising processing the detected photons over a temperature variation of 200° C. or more using an associated electronics producing signals corresponding to the detected photons.

14. The method of claim 13, further comprising increasing signal to noise ratio of the produced signals over a temperature variation of 200° C. or more, using a noise reduction electronics.

15. The method of claim 12, wherein an active area of the solid state photo multiplier has a peak quantum efficiency greater than about 40%.

16. The method of claim 12, wherein a thickness of the thin film coating is in a range from about 10 nm to about 10 microns.

17. An apparatus for detecting photons, the apparatus comprising:
a solid state photo multiplier device, comprising:
a plurality of microcells having a bandgap greater than about 1.7 eV at 25° C.;
an integrated quenching device associated with each of the microcells; and
a thin film coating on a semiconductor surface of each microcell, wherein the solid state photo multiplier device operates at a temperature ranging from about −40° C. to about 275° C.

18. The apparatus of claim 17, wherein the integrated quenching device comprises a resistor, a diode, a transistor, a capacitor, or a combination thereof.

19. The apparatus of claim 17, wherein the integrated quenching device comprises a semiconductor, a poly wide bandgap semiconductor, a polysilicon, a metal, a ceramic, or a combination thereof.

20. The apparatus of claim 17, wherein the solid state photo multiplier device comprises SiC, GaP, GaN, alloys of InxGa1-xN, alloys of AlxInyGa1-x-yN, alloys of AlxGa1-xAs, or combinations thereof, 0≦x, y≦1.

21. The apparatus of claim 17, wherein a thickness of the thin film coating is in a range from about 10 nm to about 10 microns.

22. The apparatus of claim 17, wherein the solid state photo multiplier device has a peak quantum efficiency of greater than 40%.

23. The apparatus of claim 17, wherein the solid state photo multiplier device is coupled to a scintillator configured to detect a high energy radiation.

24. The apparatus of claim 17, wherein multiple solid state photo multiplier devices are tiled adjacent to one another to cover an area of 5 mm² or greater.

25. The apparatus of claim 17, having an energy resolution less than about 50% for a radiation in a range from about 50 keV to about 10 MeV.

26. The apparatus of claim 25, having an energy resolution less than about 20% for radiation of in a range from about 50 keV to about 10 MeV.

27. The apparatus of claim 17, configured for gross counting of the detected high energy radiation at the operating temperature of the solid state photo multiplier device.

28. The apparatus of claim 17, further comprising noise reduction electronics configured to operate at the operating temperature of the solid state photo multiplier device.

29. The apparatus of claim 28, wherein the noise reduction electronics comprises a multiplexing and summing circuit.

30. The apparatus of claim 28, wherein the noise reduction electronics further comprises variable gain amplifiers.

31. The apparatus of claim 17, further comprising a microcutting device for elimination of bad pixels.

32. The apparatus of claim 17, further comprising a high energy radiation source.

33. The apparatus of claim 17, wherein the solid state photo multiplier device is configured to detect photons at a temperature greater than about 175° C.

34. The apparatus of claim 17, wherein the solid state photo multiplier device is configured to operate over a temperature variation of 200° C. or more.
